(19) United States
(12) Patent Application Publication
(10) Pub. No.: US 2011/0180109 A1
(43) Pub. Date: Jul. 28, 2011

(54) PRESSURE FLUSH PROCESS FOR COOLED TURBINE BLADES

(75) Inventors: Howard B. STILLMAN, Dartmouth (CA); Jason Paul TAYLOR, Lower Sackville (CA)

(73) Assignee: PRATT & WHITNEY CANADA CORP., Longueuil (CA)

(21) Appl. No.: 12/695,459

(22) Filed: Jan. 28, 2010

(51) Int. Cl. B08B 9/00

(52) U.S. Cl. 134/22.1

(57) ABSTRACT

A pressure flush process for removing debris from internal passageways of a cooled turbine blade includes a step of creating an agitated liquid/gas mixture and a step of injecting the agitated liquid/gas mixture under a positive pressure, into at least some of cooling holes in the blade to pass through the internal passageways and discharging the agitated liquid/gas mixture together with removed debris, through a larger root opening of the blade.

### TECHNICAL FIELD

The described subject matter relates generally to turbine engines and more particularly, to an improved pressure flush process for removing debris from internal passages of cooled turbine blades.

### BACKGROUND OF THE ART

It is know in the prior art to direct gas streams containing a soluble blast media or a solvent flow through the internal passageways of cooled turbine blades for cleaning the internal passageways during maintenance of the cooled turbine blades. Carbon-like deposits which build up in the internal passageways of the cooled turbine blades over thousands of hours of operation can be dissolved or broken up into particulates fine enough to be flushed out of the internal passageways through very fine cooling holes defined in the airfoil of cooled turbine blades. On the other hand, in a production/manufacturing environment, debris such as grinding swarf, steel shot peen material, grinding wheel fragments, etc., should also be removed from the internal passages of the cooled blades before the blades are installed in turbine engines. However, this manufacturing debris is generally indissoluble and may not escape through those small airfoil cooling holes. Prior art methods of automated cleaning lines are not very effective in removing the debris lodged in the complex internal passageways of the cooled turbine blades.

Accordingly, there is a need to provide an improved process for cleaning indissoluble debris lodged in the internal passageways of cooled turbine blades.

### SUMMARY

In accordance with one aspect, there is provided a pressure flush process for removing debris from internal passageways of a turbine blade, the internal passageways being in fluid communication with a plurality of cooling holes defined in the blade and with a root opening defined in a root section of the blade, the root opening being sized larger than the individual cooling holes, the process comprising a) creating an agitated water/air mixture; and b) injecting the agitated water/air mixture under a positive pressure into at least some of the cooling holes to pass through the internal passageways and discharging the agitated water/air mixture together with removed debris through the root opening.

In accordance with another aspect, there is provided a pressure flush process for removing indissoluble debris from internal passageways of a blade of a turbine engine, the internal passageways being in fluid communication with a plurality of cooling holes defined in the blade and with a root opening defined in a root section of the blade, the root opening being sized larger than the individual cooling holes, the process comprising a) placing the blade in an adapter such that the root section is sealingly received in a cavity of the adapter to allow the root opening to be connected in fluid communication with a draining passage extending through the adapter and allow a remaining part of the blade having at least some of the cooling holes, to project from the adapter; b) connecting the adapter to a sealable chamber with seals therebetween to allow the projecting part of the blade to be accommodated within the chamber; c) introducing a selected amount of a soap-water into the chamber, the soap-water including water with a soap solution; and d) injecting air under a positive pressure into the soap-water in the chamber to cause an agitation of the soap-water/air mixture under the positive pressure within the chamber, and allowing the agitated soap-water/air mixture to inject into the at least some of the cooling holes and further to pass through the internal passageways, and discharging the soap-water/air mixture together with debris which has been removed from the internal passageways through the draining passage in the adapter.

In accordance with a further aspect, there is provided a pressure flush process for removing debris from internal passageways of a turbine blade, the internal passageways being in fluid communication with a plurality of cooling holes defined in the blade and with a root opening defined in a root section of the blade, the root opening being sized larger than the individual cooling holes, the process comprising: a) creating an agitated liquid/gas mixture; and b) injecting the agitated liquid/gas mixture under a positive pressure into at least some of the cooling holes to pass through the internal passageways and discharging the agitated liquid/gas mixture together with removed debris through the root opening.

Further details of these and other aspects of the described subject matter will be apparent from the detailed description and figures included below.

### DESCRIPTION OF THE DRAWINGS

Reference is now made to the accompanying figures depicting aspects of the present invention, in which:

FIG. 1 is a simplified flowchart of the steps involved in one embodiment of a pressure flush process for removing indissoluble debris from internal passageways of a turbine blade;

FIG. 2 is a cross-sectional view of a turbine blade seated within a pressure flush apparatus; and

FIG. 3 is a flowchart of the steps of the pressure flush process used with the apparatus of FIG. 2, according to another embodiment.

### DETAILED DESCRIPTION OF THE PREFERRED EMBODIMENTS

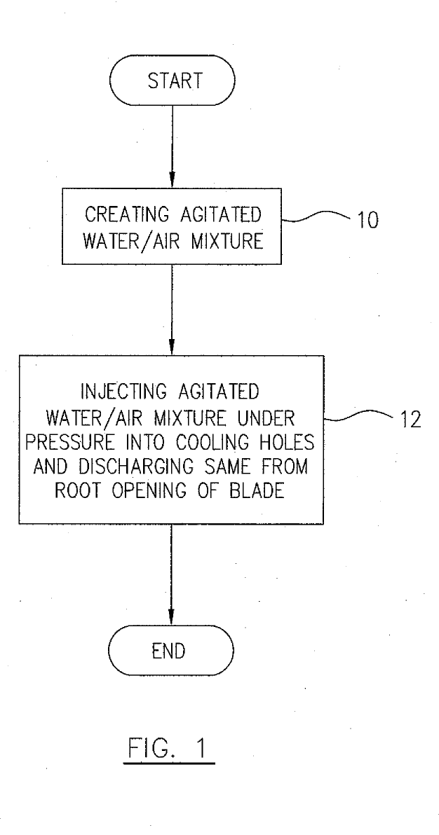

Referring to the drawings, a general principle of a pressure flush process for removing debris, particular indissoluble debris such as grinding swarf, steel shot peen material, grinding wheel fragments, etc., from internal passageways of cooled turbine blades in FIG. 1, as a simple example including step 10 of creating an agitated water/air mixture, and a step 12 of injecting the agitated water/air mixture under a pressure differential (such as applying a positive pressure to the water/air mixture) into at least some cooling holes defined in the turbine blades, to pass through the internal passageways and discharge the agitated water/air mixture with removed debris through a root opening of the blade.

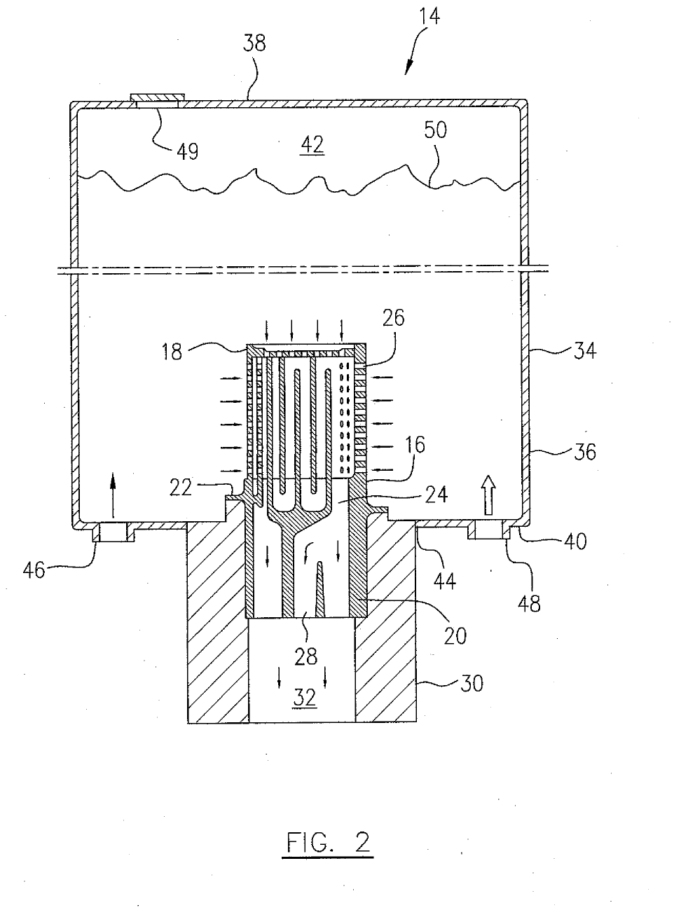

FIG. 2 illustrates an apparatus 14 used with a cooled turbine blade 16 to conduct the pressure flush process as illustrated in FIG. 1. The cooled turbine blade 16 includes an airfoil section 18, a root section 20 and a platform 22 located intermediate therebetween and transversely outwardly extending away from the blade 16. The blade 16 is of a hollow configuration to define internal passageways 24 which are in fluid communication with a plurality of very small cooling holes 26 defined, for example in the airfoil section 18. The internal passageways 24 are also in fluid communication with one or more root openings 28 which are sized much larger than the individual cooling holes 26. Therefore, cooling air (not shown) can be introduced through the root openings 28 into the internal passageways 24 to cool the blade 16 and then exit through the cooling holes 26 when the blade 16 is installed in a turbine engine for operation.

However, the manufacturing process of the blades 16 may result in debris being lodged in the internal passageways 24 of the blade 16. This debris created in the manufacturing process may include, for example, grinding swarf, steel shot peen material, grinding wheel fragments, etc. which are not dissoluble and may be too large to escape through the small cooling holes 26 defined in the airfoil section 18. This debris must be removed from the internal passageways 24 of the blade 16 prior to installation of the blade 16 in a turbine engine (not shown).

In this embodiment an adapter 30 is provided for sealingly receiving the root section 20 of the blade 16 in a cavity (not numbered) of the adapter 30 to allow the root openings 28 of the blade 16 to be connected in fluid communication with a draining passage 32 extending through the adapter 30. The remaining part of the blade 16 such as the airfoil section 18 in which the cooling holes 26 or at least some of them are defined, projects away from the adapter 30.

A sealable chamber 42 is defined in a cylinder 34 having a cylindrical wall 36 extending between a top end wall 38 and a bottom end wall 40. The cylinder 34 defines an opening 44 in the bottom end wall 40, to allow the projecting part (the airfoil section 18) of the blade 16 to be accommodated within the sealable chamber 42 when the cylinder 34 is sealingly connected to the adapter 30. A seal (not shown) may be provided in the opening 44 and around the adapter 30. The cylinder 34 further includes inlets 46 and 48, for example, defined in the bottom end wall 40, which are adapted to be sealingly connected to a source of water supply (not shown) and a source of pressurized air (not shown), respectively. The cylinder 34 may further include a closable vent opening 49 defined in the top end wall 38 or in an upper location of the cylindrical side wall 36. The sealable vent opening 49 is usually closed.

The blade 16 is placed within the apparatus 14 as shown in FIG. 2, in order to begin a pressure flush process for the blade 16 according to, for example, the embodiment shown in FIG. 1. Step 10 of creating agitated water/air mixture is achieved by first introducing water into the chamber 42 through, for example inlet 46 while inlet 48 and draining passage 32 are closed. The vent opening 49 may be open to facilitate the water intake procedure. A selected amount of water is introduced into the chamber 42 such that the entire airfoil section 18 of the blade 16, which projects from the adapter 30 and is accommodated within the chamber 42, is submerged in the water, leaving a space between a surface 50 of the water and the top end wall 38 of the chamber 42. Then inlet 46 and the vent opening 49 are closed while inlet 48 is opened to inject an air flow through inlet 48 under a positive pressure into the water contained in the chamber 42, resulting in severe agitation of the water/air mixture within the chamber 42.

Almost simultaneously to the injection of the pressurized air flow through the inlet 48, the draining passage 32 of the adapter 30 is opened, for example to the ambient pressure, such that an agitated water/air mixture is formed and is injected under that positive pressure, through the small cooling holes 26 and into the internal passageways 24 of the blade 16. Under the force of the agitated water/air mixture, the debris remaining in the internal passageways 24 is dislodged and discharged together with the exhausted water/air mixture, through the larger root opening 28 of the blade 16 and into the draining passage 32 of the adapter 30.

It is optional to supply water which is warmer than the ambient temperature for the agitated water/air mixture in this process. The water supplied for this process may not contain any solvents or solid particles which would compromise the integrity of any internal coatings (not shown) the internal passageways 24 of the blade 16 may have. Therefore, if the exhausted water/air mixture from the draining passage 32 of the adapter 30 in this process, is to be re-used as part of the water supply, an adequate filtration system (not shown) may be needed.

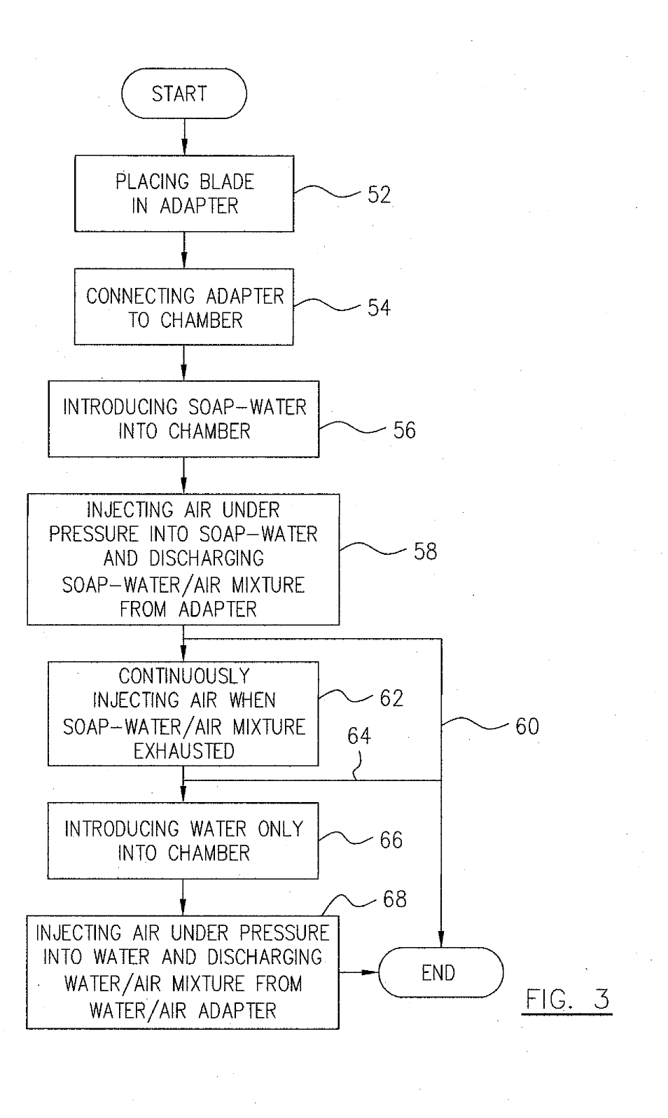

In accordance with another embodiment as illustrated in FIG. 3 in which steps 52 (placing the blade 16 in the adapter 30) and 54 (connecting the adapter 30 to the sealable chamber 42) are completed as described above with reference to FIG. 2, a selected amount of a soap-water which includes water with a soap solution, is introduced into the chamber 42 as indicated in step 56, instead of water only as shown in the embodiment of FIG. 1. The soap-water supplied for this process may have an ambient temperature or may be much warmer than the ambient temperature, if desired. Step 58 (injecting air under pressure into soap-water and discharging same from the adapter) is similar to the procedures described above with reference to steps 10 and 12 of the embodiment shown in FIG. 1. The agitated soap-water mixture under pressure of step 58, provides better lubrication than the agitated water/air mixture of step 12 of FIG. 1, when the debris in the internal passageways 24 of the blade 16 is removed and discharged.

The process according to this embodiment may end after step 58 is completed, as indicated by link 60, similar to the embodiment of FIG. 1.

Optionally, the process of this embodiment may further include a step 62 of continuously injecting air under positive pressure into the chamber 42 after the soap-water in the chamber 42 is substantially exhausted (residual soap-water may remain on the bottom end wall 40 of the cylinder 34, at a level lower than the locations of all the cooling holes 26 in the airfoil section 18 of the blade 16). Optionally, inlet 46 may be opened to drain the residual soap-water and empty the chamber 42 before step 62 is conducted. The air flow under pressure continuously injected into the internal passageways 24 of the blade 16, dries the internal passageways 24 and further removes residual debris therefrom. The process of this embodiment may end at the completion of step 62, as indicated by link 64.

Optionally, the process of this embodiment may further include step 66 of introducing only water into the chamber 42 and then a step 68 of injecting an air flow under pressure into the water within the chamber 42 and then discharging the exhausted water/air mixture from the draining passage 32 of the adapter 30.

It should be noted that in steps 66 and 68 all operational details and the resulting water/air mixture in a severe agitation, are similar, as above described with reference to the process shown in FIG. 1 and will not be repeated herein. This secondary water/air mixture resulting from steps 66 and 68 is used to wash any residual soap material from the internal passageways 24 of the blade 16.

The apparatus 14 may be optionally attached to an automated pressure flush machine (not shown) to conduct the above-described process. However, the machine is not be part of the pressure flush process described above and is not part of this application.

The configuration of the adapter 30 and the cylinder 34 as shown in FIG. 2 illustrating the apparatus 14 is exemplary and any other configuration of an apparatus for a similar function to that of apparatus 14 may be used in the pressure flush process described in this application. The cylinder 34 of FIG. 2 is for illustration purposes only and is not intended to represent an accurate size relationship with respect to the size of blade 16. The size of the cylinder 34 should define the sealable chamber 42 such that the sealable chamber 42 will contain enough water or soap-water for the flush process to substantially remove the debris in the internal passageways 24 of the blade 16.

As an alternative embodiment, the pressure differential under which the water/air mixture is injected into the cooling holes, may be achieved by applying a negative (vacuum) pressure on the root opening 28 of the blade 16 or the draining passage 32 of the adapter 30, while allowing atmospheric air to enter into the vent opening 49, resulting in an atmospheric pressure on the water/air mixture. The agitation in this embodiment will be achieved when the air/liquid recedes past each cooling hole, therefore drawing in air with the liquid and thus agitating the flow.

The above description is meant to be exemplary only, and one skilled in the art will recognize that changes may be made to the embodiments described without departure from the scope of the invention disclosed. For example, the water or soap-water used in this process may be replaced by other liquids or solutions and the air may be replaced by any gases when they are desirable. Other devices may be used, such as a manifold with nozzles which may be placed within the chamber and connected to the pressurized air inlet for creating the agitation of the water/air or soap-water/air mixture in the chamber. Although an example of the described pressure flush process is described for removing debris resulting from a manufacturing process, the described process is also applicable for flushing internal passages of cooled turbine blades as part of a maintenance process. Still other modifications which fall within the scope of the present invention will be apparent to those skilled in the art, in light of a review of this disclosure, and such modifications are intended to fall within the appended claims.

1. A pressure flush process for removing debris from internal passageways of a turbine blade, the internal passageways being in fluid communication with a plurality of cooling holes defined in the blade and with a root opening defined in a root section of the blade, the root opening being sized larger than the individual cooling holes, the process comprising:
a) creating an agitated water/air mixture; and
b) injecting the agitated water/air mixture under a positive pressure into at least some of the cooling holes to pass through the internal passageways and discharging the agitated water/air mixture together with removed debris through the root opening.

2. The process as defined in claim 1 further comprising a step, prior to step (a), of preparing respective water and air supplies for the agitated water/air mixture to avoid any solvent and solid particles in the agitated water/air mixture, which cause damage to internal coatings of the internal passageways.

3. The process as defined in claim 1 further comprising supplying water warmer than the ambient temperature for the agitated water/air mixture.

4. The process as defined in claim 1 further comprising supplying water with a soap solution for the agitated water/air mixture used in step (a).

5. The process as defined in claim 4 further comprising step (c) of injecting only air under a positive pressure into said at least some of the cooling holes and discharging same from the root opening to dry the internal passageways and remove residual debris in the internal passageways after step (b).

6. The process as defined in claim 5 further comprising step (d) of injecting a secondary agitated water/air mixture under a positive pressure into the cooling holes and discharging same from the root opening, the secondary agitated water/air mixture including water and air only in order to wash away residual soap from the internal passageways.

7. A pressure flush process for removing indissoluble debris from internal passageways of a blade of a turbine engine, the internal passageways being in fluid communication with a plurality of cooling holes defined in the blade and with a root opening defined in a root section of the blade, the root opening being sized larger than the individual cooling holes, the process comprising:
a) placing the blade in an adapter such that the root section is sealingly received in a cavity of the adapter to allow the root opening to be connected in fluid communication with a draining passage extending through the adapter and allow a remaining part of the blade having at least some of the cooling holes, to project from the adapter;
b) connecting the adapter to a sealable chamber with seals therebetween to allow the projecting part of the blade to be accommodated within the chamber;
c) introducing a selected amount of a soap-water into the chamber, the soap-water including water with a soap solution; and
d) injecting air under a positive pressure into the soap-water in the chamber to cause an agitation of the soap-water/air mixture under the positive pressure within the chamber, and allowing the agitated soap-water/air mixture to inject into the at least some of the cooling holes and further to pass through the internal passageways, and discharging the soap-water/air mixture with debris which has been removed from the internal passageways through the draining passage in the adapter.

8. The process as defined in claim 7 further comprising step (e) of continuously injecting only air under the positive pressure into the chamber after step (d), in order to allow an air flow to pass through the internal passageways to dry said internal passageways and remove residual debris from the internal passageways.

9. The process as defined in claim 8 further comprising step (f) after step (e), of repeating steps (c) and (d) wherein the soap-water used in steps (c) and (d) is replaced with water only in step (f).

10. The process as defined in claim 7 wherein the selected amount of soap-water in step (c) is determined such that the remaining part of the blade projecting from the adapter is entirely submerged in the soap-water.

11. The process as defined in claim 10 wherein the selected amount of soap-water in step (c) is determined such that there is a space between the surface of the soap-water in the chamber and a top end of the chamber.

12. The process as defined in claim 7 wherein the draining passage is closed in step (c).

13. The process as defined in claim 7 wherein the soap-water is warmer than an ambient temperature.

14. The process as defined in claim 7 wherein step (d) is continuously conducted until the surface of the soap-water is at a lower level than all of the cooling holes defined in the remaining part of the blade projecting from the adapter.

15. The process as defined in claim 7 wherein the draining passage is in fluid communication with an ambient pressure when the draining passage is open.

16. A pressure flush process for removing debris from internal passageways of a turbine blade, the internal passageways being in fluid communication with a plurality of cooling holes defined in the blade and with a root opening defined in a root section of the blade, the root opening being sized larger than the individual cooling holes, the process comprising:
a) creating an agitated liquid/gas mixture; and
b) injecting the agitated liquid/gas mixture under a pressure differential into at least some of the cooling holes to pass through the internal passageways and discharging the agitated liquid/gas mixture together with removed debris through the root opening.

17. The process as defined in claim 16 wherein the pressure differential is achieved by applying a positive pressure on the liquid/gas mixture to be injected.

18. The process as defined in claim 16 wherein the pressure differential is achieved by applying an atmospheric pressure on the liquid/gas mixture to be injected, while applying a negative pressure on an outlet of the internal passageways.

19. The process as defined in claim 16 wherein the process is performed on an as-manufactured blade prior to use of the blade in a gas turbine engine.
